(19) United States
(12) Patent Application Publication
(10) Pub. No.: US 2023/0274232 A1
(43) Pub. Date: Aug. 31, 2023

(54) METHODS, SYSTEMS, AND COMPUTER PROGRAM PRODUCTS FOR STAGED ONBOARDING OF NEW HIRES TO AN ORGANIZATION

(71) Applicant: Change Healthcare Holdings LLC, Nashville, TN (US)

(72) Inventors: Ravi Botla, Abington, MA (US); Erin Cornelius, Roswell, GA (US)

(21) Appl. No.: 17/652,506

(22) Filed: Feb. 25, 2022

(51) Int. Cl. G06Q 10/06; G06Q 10/10

(52) U.S. Cl. CPC G06Q 10/06316; G06Q 10/1053

(57) ABSTRACT

A method includes defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages; tracking completion of the one or more tasks for each one of the plurality of sequential stages; and automatically notifying, on a periodic basis, a supervising entity of which one of the sequential stages the individual is currently in based on tracking completion of the one or more tasks for each one of the plurality of sequential stages.

### FIELD

The present inventive concepts relate generally to artificial intelligence and resource management systems and, more particularly, to the application of artificial intelligence and resource management systems to onboarding of new hires to an organization.

### BACKGROUND

Surveys have shown that a significant number of new hires to a business or company do not get the equipment (e.g., laptop, desktop, logins, and the like) needed to do their job on their first day of employment. In some instances, it can take weeks for a new hire to get access to the various systems they need to do their job and to procure and install any software needed for their position. While the root causes of these problems can vary, often they are related to the many different systems, departments, and organizations involved in hiring a new employee or contractor. Due to the involvement of so many different systems and organizations, a supervising entity may have a difficult time knowing where the new hire is in the onboarding process, i.e., what tasks have been completed and what tasks are still pending. Delays in getting the necessary equipment, accounts, logins, and the like may result in productivity losses for the business or company and may also reduce goodwill between a business or company and its new hires.

### SUMMARY

According to some embodiments of the inventive concept, a method comprises: defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages; tracking completion of the one or more tasks for each one of the plurality of sequential stages; and automatically notifying, on a periodic basis, a supervising entity of which one of the sequential stages the individual is currently in based on tracking completion of the one or more tasks for each one of the plurality of sequential stages.

In other embodiments, the method further comprises: automatically notifying the supervising entity when one of the one or more tasks associated with one of the plurality of sequential stages fails to complete.

In still other embodiments, the method further comprises: automatically notifying the supervising entity when one of the one or more tasks associated with one of the plurality of sequential stages fails to complete within a defined time period.

In still other embodiments, the method further comprises: automatically notifying the supervising entity when action is required by the supervising entity to allow one of the one or more tasks associated with one of the plurality of sequential stages to complete.

In still other embodiments, tracking completion of the one or more tasks for each one of the plurality of sequential stages comprises: obtaining information associated with the one or more tasks for each one of the plurality of sequential stages from a plurality of different information source systems.

In still other embodiments, tracking completion of the one or more tasks for each one of the plurality of sequential stages comprises: applying rules to the information that has been obtained to determine a status of each of the one or more tasks for each one of the plurality of sequential stages.

In still other embodiments, the method further comprises: providing a user interface including a display of the status of each of the one or more tasks for reach one of the plurality of sequential stages.

In still other embodiments, the plurality of sequential stages comprises an offer accepted stage, a background check stage, a human resources hired stage, a day one access stage, an equipment requested stage, and an equipment delivered stage.

In still other embodiments, the one or more tasks for the offer accepted stage comprises at least one offer accepted indication; the one or more tasks for the background check stage comprises a background check initiation and/or a background check completion; the one or more tasks for the human resources hired stage comprises a human resources account creation and/or a human resources account hire status; the one or more tasks for the day one access stage comprises creation of system logins for the minimum required access based on a designated role for the individual, obtaining required software licenses, assigning a mentor, and/or registering the individual for orientation; the one or more tasks for the equipment requested stage comprises equipment request received, equipment request assigned, equipment shipped, role specific applications requested, credit card requested, and/or transportation requested; and the one or more tasks for the equipment delivered stage comprises equipment delivered, equipment request fulfillment, equipment configuration in progress, role specific applications installed, equipment configuration complete, credit card approved, and/or transportation request fulfilled.

In still other embodiments, the method further comprises: using an artificial intelligence engine to predict an onboarding satisfaction score for the individual; and using the artificial intelligence engine to identify an attention needing task from the one or more tasks corresponding to any of the plurality of sequential stages that presents a risk for negatively impacting the onboarding satisfaction score for the individual.

In still other embodiments, the method further comprises: automatically notifying the supervising entity of the attention needing task.

In still other embodiments, the artificial intelligence engine is trained using historical onboarding satisfaction scores for previously onboarded individuals, respectively, and characteristics associated with each of the previously onboarded individuals; and the characteristics comprise a personnel category type, a personnel category sub-type, a number of days taken for background verification, equipment types requested, supervising entity response rate, assigned internal organization.

In still other embodiments, using the artificial intelligence engine to predict the onboarding satisfaction score for the individual comprises: using the artificial intelligence engine to predict the onboarding satisfaction score for the individual and using the artificial intelligence engine to identify the attention needing task based on the personnel category type for the individual, the personnel category sub-type for the individual, the number of days taken for background verification for the individual, the equipment types requested for the individual, an inventory status of the equipment in stock, the supervising entity response rate for the individual, the assigned internal organization for the individual, and a number of days remaining for onboarding.

In some embodiments of the inventive concept, a system comprises a processor and a memory coupled to the processor and comprising computer readable program code embodied in the memory that is executable by the processor to perform operations comprising: defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages; tracking completion of the one or more tasks for each one of the plurality of sequential stages; and automatically notifying, on a periodic basis, a supervising entity of which one of the sequential stages the individual is currently in based on tracking completion of the one or more tasks for each one of the plurality of sequential stages.

In further embodiments, the operations further comprise: automatically notifying the supervising entity when one of the one or more tasks associated with one of the plurality of sequential stages fails to complete.

In still further embodiments, the operations further comprise: automatically notifying the supervising entity when one of the one or more tasks associated with one of the plurality of sequential stages fails to complete within a defined time period.

In still further embodiments, the operations further comprise: automatically notifying the supervising entity when action is required by the supervising entity to allow one of the one or more tasks associated with one of the plurality of sequential stages to complete.

In still further embodiments, the operations further comprise: using an artificial intelligence engine to predict an onboarding satisfaction score for the individual; and using the artificial intelligence engine to identify an attention needing task from the one or more tasks corresponding to any of the plurality of sequential stages that presents a risk for negatively impacting the onboarding satisfaction score for the individual.

In some embodiments of the inventive concept, a computer program product, comprises a non-transitory computer readable storage medium comprising computer readable program code embodied in the medium that is executable by a processor to perform operations comprising: defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages; tracking completion of the one or more tasks for each one of the plurality of sequential stages; and automatically notifying, on a periodic basis, a supervising entity of which one of the sequential stages the individual is currently in based on tracking completion of the one or more tasks for each one of the plurality of sequential stages.

In other embodiments, the operations further comprise: using an artificial intelligence engine to predict an onboarding satisfaction score for the individual; and using the artificial intelligence engine to identify an attention needing task from the one or more tasks corresponding to any of the plurality of sequential stages that presents a risk for negatively impacting the onboarding satisfaction score for the individual.

Other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including a staged onboarding system for new hires to an organization in accordance with some embodiments of the inventive concept;

FIG. 2 is a block diagram of a multi-stage onboarding system for new hires according to some embodiments of the inventive concept;

FIG. 3 is a block diagram of an Artificial Intelligence (AI) system for predicting new hire satisfaction scores and/or identifying tasks in the staged onboarding process that need attention according to some embodiments of the inventive concept;

FIGS. 4-6 are flowcharts that illustrate operations of the staged onboarding system for new hires including the AI system according to some embodiments of the inventive concept;

FIG. 7 is a diagram of a user interface for use with the staged onboarding system for new hires according to some embodiments of the inventive concept;

FIG. 8 is a data processing system that may be used to implement one or more servers in the staged onboarding system for new hires including the AI system of FIG. 1 according to some embodiments of the inventive concept; and

FIG. 9 is a block diagram that illustrates a software/hardware architecture for use in the staged onboarding system for new hires including the AI system of FIG. 1 according to some embodiments of the inventive concept.

### DETAILED DESCRIPTION

In the following detailed description, numerous specific details are set forth to provide a thorough understanding of embodiments of the present inventive concept. However, it will be understood by those skilled in the art that the present invention may be practiced without these specific details. In some instances, well-known methods, procedures, components, and circuits have not been described in detail so as not to obscure the present inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the inventive concept are described herein in the context of a staged onboarding system for new hires that includes a machine learning engine and an artificial intelligence (AI) engine. It will be understood that embodiments of the inventive concept are not limited to a machine learning implementation of the satisfaction score prediction engine or the task identification engine and other types of AI systems may be used including, but not limited to, a multi-layer neural network, a deep learning system, a natural language processing system, and/or computer vision system. Moreover, it will be understood that the multi-layer neural network is a multi-layer artificial neural network comprising artificial neurons or nodes and does not include a biological neural network comprising real biological neurons. In other embodiments, the satisfaction score prediction engine or the task identification engine may be implemented without using AI using procedural and/or objected oriented computer readable program code, for example, in combination with processing and networking elements.

Embodiments of the inventive concept are described herein in the context of a supervising entity overseeing the onboarding process for a new hire to an organization. It will be understood that the supervising entity may be a single person, such as a new hire's manager or supervisor, a contact person in a human resources department, or any other person assigned to the role of managing the onboarding process for a new hire. The supervising entity may also be a collection of multiple people from a same or different department within an organization, including, but not limited to, a human resources department, a group of managers from the department to which the new hire will assigned, or a combination of individuals from human resources and the department to which the new hire will be assigned.

Some embodiments of the inventive concept stem from a realization that due to the many different systems, departments, and organizations involved in hiring a new employee or contractor, a business or company is often not prepared for the new hire on the first day the individual shows up for work. This may be manifest in a variety of ways including, but not limited to, missing equipment (e.g., laptop or computer not available), accounts or logins on applicable systems not being setup, or even failure to ensure the appropriate people are available to greet the new hire (e.g., mentor or manager) and guide the new hire through the first day. These delays in getting the necessary equipment, accounts, logins, and the like may result in productivity losses for the business or company and may also reduce goodwill between the new hire and the business or company. Some embodiments of the inventive concept provide a staged onboarding system that is configured to manage the process of onboarding a new hire from offer to the time that the new hire starts with the business or company. The staged onboarding system may obtain and consolidate information from multiple information source systems, including, but not limited to, human resources, payroll, purchasing/procurement, information technology (IT), talent acquisition (recruiting), and/or background check, and may define tasks to be completed in various stages during the onboarding process. The tasks in one stage must be completed before the onboarding process can proceed to the next stage based on rules that are defined, which create dependencies between tasks in different stages and, in some instances, between tasks in the same stage. The rules may also define when a task is complete or has failed or is delayed. For example, a rule may be defined that a laptop for a new hire should be ordered within three days of a starting date being identified. The task may be delayed if the laptop is not ordered within the three days or may be considered to have failed if the order is rejected or is not ordered within two weeks after the starting date is identified. A supervising entity may be automatically notified of task failures, delays, and/or when the supervising entity needs to take action to complete a task (e.g., approve an equipment request). The notifications can be generated in a variety of different ways including electronic mail, short message service (SMS), and the like.

The staged onboarding system may also provide a user interface that shows the stage the new hire is currently in during the onboarding process and the status of the tasks in the various stages, such as complete, in progress, failed, and/or delayed. In some embodiments, the user interface may be configured to define the various stages and the tasks included therein in accordance with the preferences of a supervising entity, for example.

New hires may, in some organizations, be given a survey to rate their onboarding experience, which results in an onboarding satisfaction score. Some embodiments of the inventive concept may provide an AI engine that is used to predict an onboarding satisfaction score for an individual who is newly hired. The AI engine may also identify one or more tasks that need attention from the supervising entity because these tasks may, for example, present a risk for negatively impacting the onboarding satisfaction score for the new hire. By identifying these tasks and notifying the supervising entity of their potential to be problematic, problems in the onboarding process may be averted and the overall onboarding process may be improved.

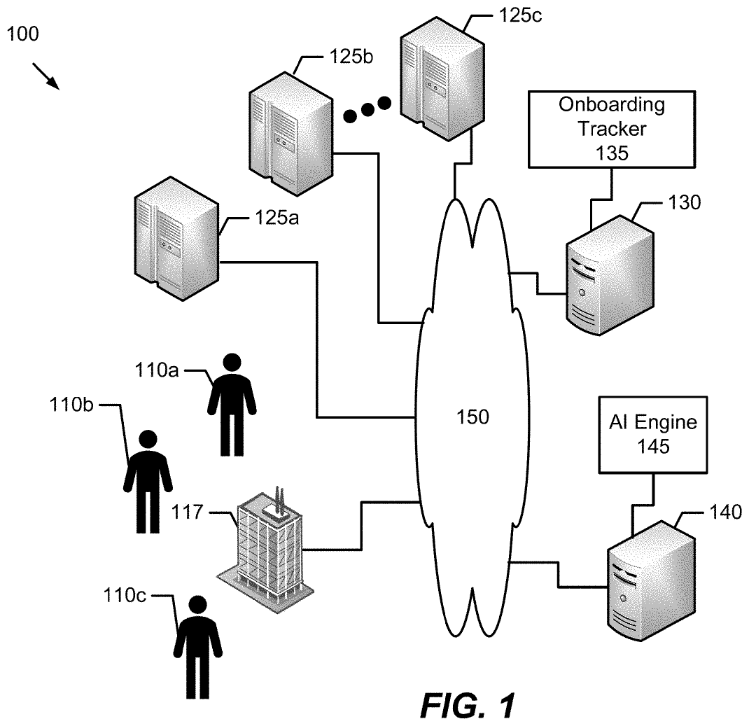

Referring to FIG. 1, a communication network 100 including a staged onboarding system including an AI system, in accordance with some embodiments of the inventive concept, comprises an onboarding server 130 including an onboarding tracker module 135 that is configured to execute thereon and an AI server 140 including an AI engine module 145 that is configured to execute thereon. The onboarding server 130 may be configured to obtain and consolidate information from multiple information source systems, which are represented as systems 125a, 125b, and 125c, and may include, but are not limited to, human resources, payroll, purchasing/procurement, information technology (IT), talent acquisition (recruiting), and/or background check systems for onboarding new hires 110a, 110b, and 110c to a company or business 117. The information obtained from these information source systems 125a, 125b, and 125c may be used in a defined sequential staged onboarding system defined using the onboarding server 130. Each stage in the onboarding process may have one or more tasks associated therewith, which must be completed before the new hire may transition to a subsequent stage in the process. The onboarding server 130 may be configured to implement defined rules that enforce dependencies between tasks associated with different stages as well as dependencies between tasks in the same stage. The rules may also be used to determine when a task is pending, completed, failed, and/or delayed, for example. The onboarding server 130 may be further configured to track the completion of the one or more tasks in the various onboarding stages and to automatically notify, on a periodic basis, a supervising entity of the current status of the onboarding process, e.g., which stage a new hire is currently in. The onboarding server 130 may also be configured to notify the supervising entity when a task fails to complete, fails to complete within a defined time period, e.g., is delayed, and/or action is required by the supervising entity to allow the task to complete (e.g., waiting on the supervising entity to authorize a purchase).

As described above, new hires may be given a survey to rate their onboarding experience, which results in an onboarding satisfaction score. The AI server 140 may be configured to predict an onboarding satisfaction score for a new hire. The AI server 140 may be further configured to identify one or more tasks that need attention from the supervising entity because these tasks may, for example, present a risk for negatively impacting the onboarding satisfaction score for a new hire. Thus, the prediction capabilities of the AI server 140 may be used to identify potentially problematic tasks in onboarding individuals into the business or company 117 and bringing these problematic tasks to the attention of a supervising entity who can ensure these tasks get the attention that they need to address them before they negatively impact the onboarding process.

It will be understood that the division of functionality described herein between the AI server 140/AI engine module 145 and the onboarding server 130/onboarding tracker module 135 is an example. Various functionality and capabilities can be moved between the AI server 140/AI engine module 145 and the onboarding server 130/onboarding tracker module 135 in accordance with different embodiments of the inventive concept. Moreover, in some embodiments, the AI server 140/AI engine module 145 and the onboarding server 130/onboarding tracker module 135 may be merged as a single logical and/or physical entity.

A network 150 couples the business or company 117 and the information source systems 125a, 125b, and 125c to the onboarding server 130 and the AI server 140. The network 150 may be a global network, such as the Internet, Public Switched Telephone Network (PSTN), or other publicly accessible network. Various elements of the network 150 may be interconnected by a wide area network, a local area network, an Intranet, and/or other private network, which may not be accessible by the general public. Thus, the communication network 150 may represent a combination of public and private networks or a virtual private network (VPN). The network 150 may be a wireless network, a wireline network, or may be a combination of both wireless and wireline networks.

The service provided through the onboarding server 130/onboarding tracker module 135 and/or the AI server 140/AI engine module 145 for performing staged onboarding of new hires to an organization may, in some embodiments, be embodied as a cloud service. For example, the business or company 117 may be configured to access the semantic staged onboarding service for new hires as a Web service. In some embodiments, the staged onboarding service for new hires and/or the AI services may be implemented as Representational State Transfer Web Services (RESTful Web services).

Although FIG. 1 illustrates an example communication network including a staged onboarding system for new hires to an organization including an AI system, it will be understood that embodiments of the inventive concept are not limited to such configurations, but are intended to encompass any configuration capable of carrying out the operations described herein.

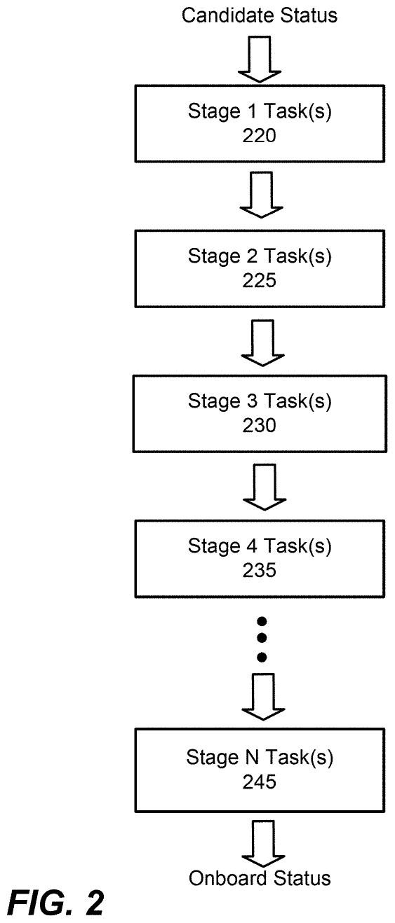

FIG. 2 is a block diagram of a multi-stage onboarding system for new hires according to some embodiments of the inventive concept. As shown in FIG. 2, a new hire may approach an organization or be recruited by an organization as a candidate. The new hire may then be onboarded into the organization using a sequentially staged onboarding process after which the new hire may be considered to have been fully onboarded. In the example of FIG. 2, the onboarding process is divided into N stages 220, 225, 230, 235 and 245. Each one of the stages has one or more tasks associated therewith, which are required to be completed before the onboarding process for the new hire can proceed to the next stage. In accordance with some embodiments of the inventive concept, the number of stages and assignment of tasks to the various stages may be configurable through user (e.g., a supervising authority) input. In some embodiments of the inventive concept, six stages may be defined, which may include an offer accepted stage, a background check stage, a human resources hired stage, a day one access stage, an equipment requested stage, and an equipment delivered stage. The one or more tasks for the offer accepted stage may comprise at least one offer accepted indication; the one or more tasks for the background check stage may comprise a background check initiation and/or a background check completion; the one or more tasks for the human resources hired stage may comprise a human resources account creation and/or a human resources account hire status; the one or more tasks for the day one access stage may comprise creation of system logins for the minimum required access based on a designated role for the individual, obtaining required software licenses, assigning a mentor, and/or registering the individual for orientation; the one or more tasks for the equipment requested stage may comprise equipment request received, equipment request assigned, equipment shipped, role specific applications requested, credit card requested, and/or transportation requested; and the one or more tasks for the equipment delivered stage may comprise equipment delivered, equipment request fulfillment, equipment configuration in progress, role specific applications installed, equipment configuration complete, credit card approved, and/or transportation request fulfilled.

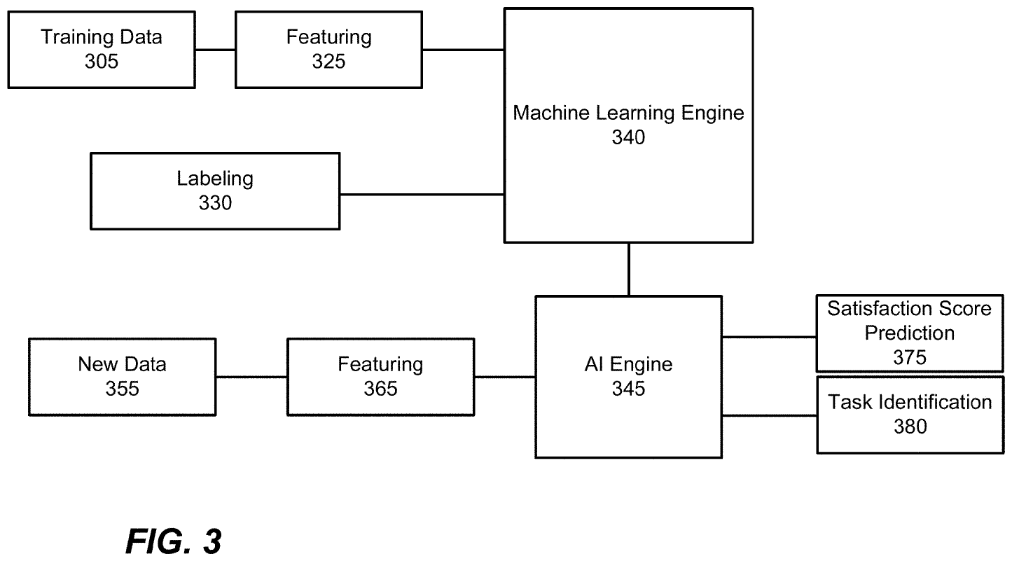

As described above, the staged onboarding system for new hires to an organization may include an AI system that is configured to predict an onboarding satisfaction score for an individual who is newly hired and/or identify one or more tasks that need attention from the supervising entity because these tasks may, for example, present a risk for negatively impacting the onboarding satisfaction score for the new hire. FIG. 3 is a block diagram of the AI engine 145 used in the staged onboarding system for new hires to an organization in accordance with some embodiments of the inventive concept. As shown in FIG. 3, the AI engine 145 may include both training modules and modules used for processing new data on which to make satisfaction score predictions and/or problematic task identifications. The modules used in the training portion of the AI engine 145 include the training data 305, the featuring module 325, the labeling module 330, and the machine learning engine 340. The training data 305 may comprise information associated with the historical onboarding of new hires by the business or company 117 including onboarding satisfaction scores for previously onboarded individuals and characteristics associated with these previously onboarded individuals. In some embodiments of the inventive concept, the characteristics may comprise a personnel category type (e.g., full time employee, contractor, etc.), a personnel category sub-type (e.g., full time, part time, seasonal, intern, etc.), a number of days taken for background verification, equipment types requested, supervising entity response rate (e.g., how rapidly does the supervising entity respond to requests to complete tasks that are part of the onboarding process), and/or assigned internal organization. The featuring module 325 is configured to identify the individual independent variables that are used by the AI engine 145 to make onboarding satisfaction score predictions and/or identify potentially problematic onboarding tasks, which may be considered dependent variables. The training data 305 may be generally unprocessed or formatted and include extra information, which can be filtered out by the featuring module 325. The features extracted from the training data 305 may be called attributes and the number of features may be called the dimension. The labeling module 330 may be configured to assign defined labels to the featured training data and to the generated onboarding satisfaction score predictions and/or identified tasks to ensure a consistent naming convention for both the input features and the output predictions. The machine learning engine 340 may process the featured training data 305, including the labels provided by the labeling module 330, and may be configured to test numerous functions to establish a quantitative relationship between the featured and labeled input data and predicted outputs. The machine learning engine 340 may use regression techniques to evaluate the effects of various input data features on the predicted onboard satisfaction score outputs and/or identified problematic task outputs. These effects may then be used to tune and refine the quantitative relationship between the featured and labeled input data and the predicted outputs. The tuned and refined quantitative relationship between the featured and labeled input data generated by the machine learning engine 340 is output for use in the AI engine 345. The machine learning engine 340 may be referred to as a machine learning algorithm.

The modules used for processing new data on which to make onboarding satisfaction score predictions and/or problematic task identifications include the new data 355, the featuring module 365, the AI engine module 345, the satisfaction score prediction module 375, and the task identification module 380. The new data 355 may be at least a portion of the data/information used as the training data 305 in content and form except the data will be used for an individual who is a new hire and who is currently going through the staged onboarding process. For example, the new data 355 may include the personnel category type for the individual, the personnel category sub-type for the individual, the number of days taken for background verification for the individual, the equipment types requested for the individual, an inventory status of the equipment in stock, the supervising entity response rate for the individual, the assigned internal organization for the individual, and a number of days remaining for onboarding. Likewise, the featuring module 365 performs the same functionality on the new data 355 as the featuring module 325 performs on the training data 305. The AI engine 345 may, in effect, be generated by the machine learning engine 340 in the form of the quantitative relationship determined between the featured and labeled input data and the predicted outputs. The AI engine 345 may, in some embodiments, be referred to as an AI model. The AI engine 345 may be configured to output an onboarded satisfaction score prediction for an individual that is going through the staged onboarding process as a new hire via the satisfaction score prediction module 375 and may be configured to output one or more tasks that may be likely to negatively impact the onboarding satisfaction score for the individual via the task identification module 380. The satisfaction score prediction module 375 and the task identification module 380 may be configured to communicate the predicted outputs in a variety of display formats. The task identification module 380 may be configured to automatically notify the supervising entity of the potentially problematic tasks so that such tasks may be given the necessary attention to mitigate or eliminate their problematic impact on the onboarding process.

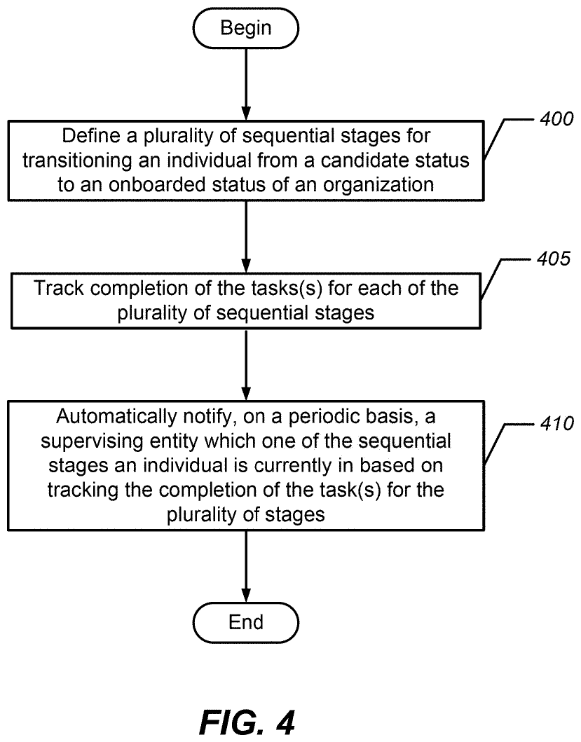

FIGS. 4-6 are flowcharts that illustrate operations of the staged onboarding system for new hires including the AI system according to some embodiments of the inventive concept. Referring now to FIG. 4, operations begin at block 400 where a plurality of sequential stages for transitioning an individual from candidate status to an onboarded status for an organization are defined, such as shown in FIG. 2. Each of the plurality of sequential stages includes one or more tasks associated therewith. Rules are defined to enforce the requirement that each task associated with a stage must be completed before the onboarding process for the individual can proceed to the next stage in the sequence. The completion of task(s) in each of the plurality of stages is tracked at block 405 and a supervising entity is automatically notified at block 410, on a periodic basis, which one of the sequential stages an individual is currently in based on the tasks that have been completed and which tasks remain pending.

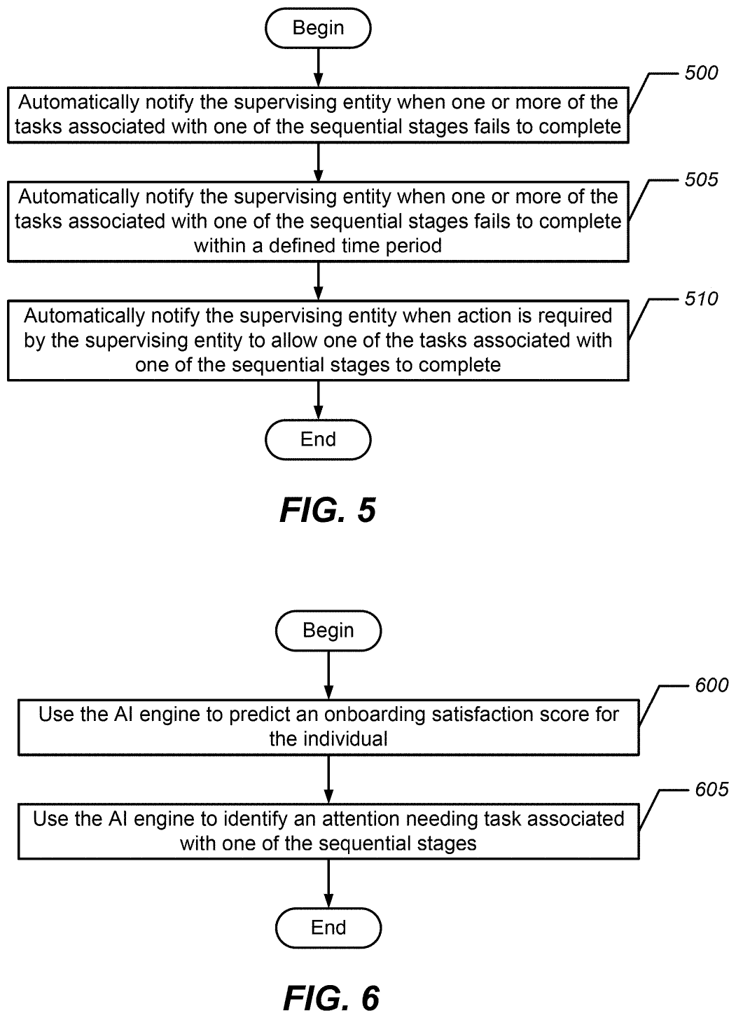

Referring now to FIG. 5, the supervising entity may also be notified on a periodic basis or in real time (i.e., without the insertion of any scheduled or artificial delays) when any of the tasks prove to be problematic. For example, the supervising entity may be notified when one or more of the tasks associated with a stage fails to complete at block 500. The supervising entity may also be automatically notified when one or more tasks associated with a stage fails to complete within a defined time period (e.g., are delayed past an expected completion date) at block 505. As a further example, the supervising entity may be automatically notified when action is required of the supervising entity to allow one or more tasks associated with a stage to compete (e.g., authorization from the supervising entity is needed for a purchase). Such notifications may allow the supervising entity to act on a timely basis to resolve any problems or roadblocks that may come up during the onboarding process for new hires.

As described above, the staged onboarding system for new hires to an organization may make use of AI technology to assist in the onboarding process. Referring now to FIG. 6, The AI engine 145/345 may be configured to predict an onboarding satisfaction score at block 600 for an individual that is currently going through the onboarding process as described above with respect to FIG. 3. The AI engine 145/345 may also be used to identify any tasks that may potentially need attention from the supervising entity based on a likelihood that these tasks may negatively impact the onboarding satisfaction score for an individual being onboarded at block 605. The supervising entity may be notified of the predicted onboarding satisfaction score and/or the identified tasks that may need attention thereby allowing the supervising entity to take action to mitigate the negative impact on the onboarding process of any problems that may arise or even avert the problems altogether.

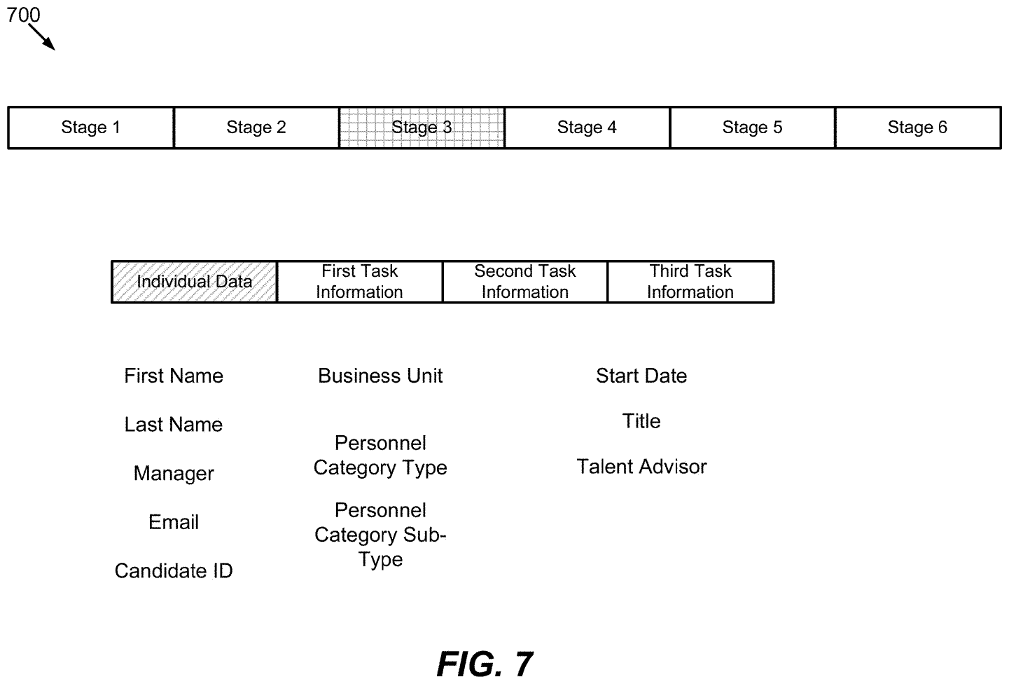

The staged onboarding system for new hires to an organization, according to some embodiments of the inventive concept, may provide a user interface to allow a user, such as a supervising entity, the ability to view what stage of the onboarding process the individual is in as well as see the status of tasks associated with the various stages. FIG. 7 is a diagram of a user interface 700 for use with the staged onboarding system for new hires according to some embodiments of the inventive concept. In the example user interface 700, a status bar is provided at the top, which shows which stage of the onboarding process the individual is currently in. In the example shown, the individual is in Stage 3 of the onboarding process based on the different backlighting of Stage 3 relative to the other stages. The task information can be organized in a variety of ways. In some embodiments, all of the tasks associated with a Stage may be organized together. In other embodiments, tasks may be organized separately according to subject matter with tasks associated with different stages of the onboarding process displayed together. In the example shown in FIG. 7, there are six stages used in the onboarding process and the tasks are organized into four groups. The individual data group is currently displayed in the example of FIG. 7. The status of tasks may be communicated in a variety of ways including a checkbox, font variations, color variations, and the like. The status may include, but is not limited to, pending, completed, failed, and/or delayed. In some embodiments, a user, such as a supervising entity, may configure the layout of the user interface 700 including the number of stages, which tasks are associated with each stage, whether the tasks are organized by stage and/or subject matter, the periodicity of notifications generated for stage updates, task failures, task delays, or other task problems (e.g., supervising entity input needed), and the like.

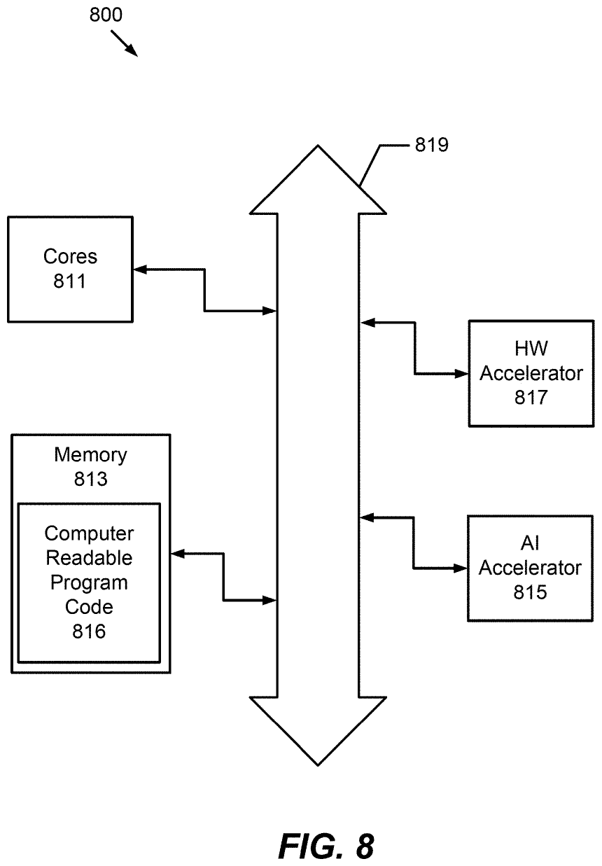

FIG. 8 is a block diagram of a data processing system 800 that may be used to implement the staged onboarding system for new hires of FIG. 1 in accordance with some embodiments of the inventive concept. As shown in FIG. 8, the data processing system 800 may include at least one core 811, a memory 813, an Artificial Intelligence (AI) accelerator 815, and a hardware (HW) accelerator 817. The at least one core 811, the memory 813, the AI accelerator 815, and the HW accelerator 817 may communicate with each other through a bus 819.

The at least one core 811 may be configured to execute computer program instructions. For example, the at least one core 811 may execute an operating system and/or applications represented by the computer readable program code 816 stored in the memory 813. In some embodiments, the at least one core 811 may be configured to instruct the AI accelerator 815 and/or the HW accelerator 817 to perform operations by executing the instructions and obtain results of the operations from the AI accelerator 815 and/or the HW accelerator 817. In some embodiments, the at least one core 811 may be an ASIP customized for specific purposes and support a dedicated instruction set.

The memory 813 may have an arbitrary structure configured to store data. For example, the memory 813 may include a volatile memory device, such as dynamic random-access memory (DRAM) and static RAM (SRAM), or include a non-volatile memory device, such as flash memory and resistive RAM (RRAM). The at least one core 811, the AI accelerator 815, and the HW accelerator 817 may store data in the memory 813 or read data from the memory 813 through the bus 819.

The AI accelerator 815 may refer to hardware designed for AI applications, such as predicting onboarding satisfaction scores and/or identifying potentially problematic tasks in the onboarding process in accordance with embodiments described herein. The AI accelerator 815 may generate output data by processing input data provided from the at least one core 815 and/or the HW accelerator 817 and provide the output data to the at least one core 811 and/or the HW accelerator 817. In some embodiments, the AI accelerator 815 may be programmable and be programmed by the at least one core 811 and/or the HW accelerator 817. The HW accelerator 817 may include hardware designed to perform specific operations at high speed. The HW accelerator 817 may be programmable and be programmed by the at least one core 811.

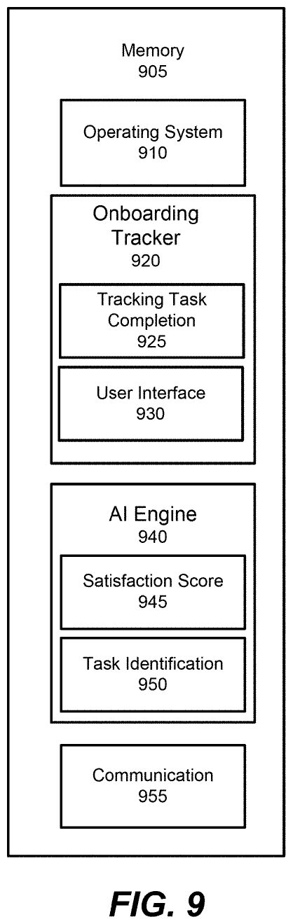

FIG. 9 illustrates a memory 905 that may be used in embodiments of data processing systems, such as the staged onboarding system for new hires to an organization of FIG. 1 and the data processing system 800 of FIG. 8, respectively, to facilitate operation of the AI server 140/AI engine module 145 and the onboarding server 130/onboarding tracker module 135 according to some embodiments of the inventive concept. The memory 905 is representative of the one or more memory devices containing the software and data used for facilitating operations of the staged onboarding system for new hires of FIG. 1 as described herein. The memory 905 may include, but is not limited to, the following types of devices: cache, ROM, PROM, EPROM, EEPROM, flash, SRAM, and DRAM. As shown in FIG. 9 the memory 905 may contain four or more categories of software and/or data: an operating system 910, an onboarding tracker module 920, an AI engine module 940, and a communication module 955. In particular, the operating system 910 may manage the data processing system's software and/or hardware resources and may coordinate execution of programs by the processor. The onboarding tracker module 920 may be configured to implement the onboarding tracker module 135 of FIG. 1 and may include a tracking task completion module 925 and a user interface module 930. The tracking task completion module 925 may be configured to perform one or more of the operations of the flowcharts of FIGS. 4-6 and operations described with respect to the block diagram of FIG. 2. The user interface module 930 may be configured to perform one or more of the operations of the flowcharts of FIGS. 4-6 and the operations described with respect to the user interface 700 of FIG. 7.

The AI engine 940 may be configured to implement the AI engine module 145 and may include a satisfaction score module 945 and a task identification module 950. The satisfaction score module 945 and the task identification module 950 may be configured to perform one or more of the operations describe above with respect to the AI system of FIG. 3 and the flowcharts of FIGS. 4-6. The communication module 955 may be configured to facilitate communication between the onboarding server 130/onboarding tracker module 135 and the AI server 140/AI engine module 145 and between the AI server 140/AI engine module 145 and the onboarding server 130/onboarding tracker module 135 and the information source system 125a, 125b, and 125c and business or company 117.

Although FIGS. 8 and 9 illustrate hardware/software architectures that may be used in data processing systems, such as the staged onboarding system for new hires of FIG. 1 and the data processing system 800 of FIG. 8 in accordance with some embodiments of the inventive concept, it will be understood that embodiments of the present inventive concept are not limited to such a configuration but are intended to encompass any configuration capable of carrying out operations described herein.

Computer program code for carrying out operations of data processing systems described above with respect to FIGS. 1-9 may be written in a high-level programming language, such as Python, Java, C, and/or C++, for development convenience. In addition, computer program code for carrying out operations of the present invention may also be written in other programming languages, such as, but not limited to, interpreted languages. Some components or routines may be written in assembly language or even micro-code to enhance performance and/or memory usage. It will be further appreciated that the functionality of any or all of the program components may also be implemented using discrete hardware components, one or more application specific integrated circuits (ASICs), or a programmed digital signal processor or microcontroller.

Moreover, the functionality of the staged onboarding system for new hires of FIG. 1 and the data processing system 800 of FIG. 8 may each be implemented as a single processor system, a multi-processor system, a multi-core processor system, or even a network of stand-alone computer systems, in accordance with various embodiments of the inventive concept. Each of these processor/computer systems may be referred to as a “processor” or “data processing system.”

The data processing apparatus described herein with respect to FIGS. 1-9 may be used to facilitate operations of staged onboarding of new hires to an organization according to some embodiments of the inventive concept described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 905 when coupled to a processor includes computer readable program code that, when executed by the processor, causes the processor to perform operations including one or more of the operations described herein with respect to FIGS. 1-7.

Some embodiments of the inventive concept may provide a staged onboarding system including an AI system for a new hire to an organization, which integrates the many disparate systems involved the process or onboarding a new hire into a single interface to allow a supervising entity to quickly see where a new hire is in the onboarding process and which tasks are completed and which are still outstanding. Moreover, the onboarding system provides rules for organizing the staged onboarding process and identifying tasks that are failed or delayed. Automatic notification of the status of the onboarding process including identification of failed or delayed tasks may allow the supervising entity to intervene in the process to address issues in a timely manner. The staged onboarding system may further make use of AI to predict an individual's onboarding satisfaction score and/or to identify one or more tasks that are likely to negatively impact the onboarding satisfaction score for the individual. This may allow a supervising entity to devote extra attention to those tasks that have a high likelihood of being problematic and any problems may, therefore, be averted. The staged onboarding system including the AI system, according to some embodiments, may provide for an improved experience in onboarding new hires to a business or company, which can improve productivity for the business or company and/or improve goodwill between the business or company and new hires. This may make the business or company more attractive to new hires while also being financially beneficial to the business or company.

### Further Definitions and Embodiments

In the above description of various embodiments of the present inventive concept, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present inventive concept. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

In the above-description of various embodiments of the present inventive concept, aspects of the present inventive concept may be illustrated and described herein in any of a number of patentable classes or contexts including any new and useful process, machine, manufacture, or composition of matter, or any new and useful improvement thereof. Accordingly, aspects of the present inventive concept may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present inventive concept may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A method, comprising:
defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages;
tracking completion of the one or more tasks for each one of the plurality of sequential stages; and
automatically notifying, on a periodic basis, a supervising entity of which one of the sequential stages the individual is currently in based on tracking completion of the one or more tasks for each one of the plurality of sequential stages.

2. The method of claim 1, further comprising:
automatically notifying the supervising entity when one of the one or more tasks associated with one of the plurality of sequential stages fails to complete.

3. The method of claim 1, further comprising:
automatically notifying the supervising entity when one of the one or more tasks associated with one of the plurality of sequential stages fails to complete within a defined time period.

4. The method of claim 1, further comprising:
automatically notifying the supervising entity when action is required by the supervising entity to allow one of the one or more tasks associated with one of the plurality of sequential stages to complete.

5. The method of claim 1, wherein tracking completion of the one or more tasks for each one of the plurality of sequential stages comprises:
obtaining information associated with the one or more tasks for each one of the plurality of sequential stages from a plurality of different information source systems.

6. The method of claim 5, wherein tracking completion of the one or more tasks for each one of the plurality of sequential stages comprises:
applying rules to the information that has been obtained to determine a status of each of the one or more tasks for each one of the plurality of sequential stages.

7. The method of claim 6, further comprising:
providing a user interface including a display of the status of each of the one or more tasks for reach one of the plurality of sequential stages.

8. The method of claim 1, wherein the plurality of sequential stages comprises an offer accepted stage, a background check stage, a human resources hired stage, a day one access stage, an equipment requested stage, and an equipment delivered stage.

9. The method of claim 8, wherein the one or more tasks for the offer accepted stage comprises at least one offer accepted indication;
wherein the one or more tasks for the background check stage comprises a background check initiation and/or a background check completion;
wherein the one or more tasks for the human resources hired stage comprises a human resources account creation and/or a human resources account hire status;
wherein the one or more tasks for the day one access stage comprises creation of system logins for the minimum required access based on a designated role for the individual, obtaining required software licenses, assigning a mentor, and/or registering the individual for orientation;
wherein the one or more tasks for the equipment requested stage comprises equipment request received, equipment request assigned, equipment shipped, role specific applications requested, credit card requested, and/or transportation requested; and
wherein the one or more tasks for the equipment delivered stage comprises equipment delivered, equipment request fulfillment, equipment configuration in progress, role specific applications installed, equipment configuration complete, credit card approved, and/or transportation request fulfilled.

10. The method of claim 1, further comprising:
using an artificial intelligence engine to predict an onboarding satisfaction score for the individual; and
using the artificial intelligence engine to identify an attention needing task from the one or more tasks corresponding to any of the plurality of sequential stages that presents a risk for negatively impacting the onboarding satisfaction score for the individual.

11. The method of claim 10, further comprising:
automatically notifying the supervising entity of the attention needing task.

12. The method of claim 10, wherein the artificial intelligence engine is trained using historical onboarding satisfaction scores for previously onboarded individuals, respectively, and characteristics associated with each of the previously onboarded individuals; and
wherein the characteristics comprise a personnel category type, a personnel category sub-type, a number of days taken for background verification, equipment types requested, supervising entity response rate, assigned internal organization.

13. The method of claim 12, wherein using the artificial intelligence engine to predict the onboarding satisfaction score for the individual comprises:
using the artificial intelligence engine to predict the onboarding satisfaction score for the individual and using the artificial intelligence engine to identify the attention needing task based on the personnel category type for the individual, the personnel category sub-type for the individual, the number of days taken for background verification for the individual, the equipment types requested for the individual, an inventory status of the equipment in stock, the supervising entity response rate for the individual, the assigned internal organization for the individual, and a number of days remaining for onboarding.

14. A system, comprising:
a processor; and
a memory coupled to the processor and comprising computer readable program code embodied in the memory that is executable by the processor to perform operations comprising:
defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages;
tracking completion of the one or more tasks for each one of the plurality of sequential stages; and
automatically notifying, on a periodic basis, a supervising entity of which one of the sequential stages the individual is currently in based on tracking completion of the one or more tasks for each one of the plurality of sequential stages.

15. The system of claim 14, wherein the operations further comprise:
automatically notifying the supervising entity when one of the one or more tasks associated with one of the plurality of sequential stages fails to complete.

16. The system of claim 14, wherein the operations further comprise:
automatically notifying the supervising entity when one of the one or more tasks associated with one of the plurality of sequential stages fails to complete within a defined time period.

17. The system of claim 14, wherein the operations further comprise:
automatically notifying the supervising entity when action is required by the supervising entity to allow one of the one or more tasks associated with one of the plurality of sequential stages to complete.

18. The system of claim 14, wherein the operations further comprise:
using an artificial intelligence engine to predict an onboarding satisfaction score for the individual; and
using the artificial intelligence engine to identify an attention needing task from the one or more tasks corresponding to any of the plurality of sequential stages that presents a risk for negatively impacting the onboarding satisfaction score for the individual.

19. A computer program product, comprising:
a non-transitory computer readable storage medium comprising computer readable program code embodied in the medium that is executable by a processor to perform operations comprising:
defining a plurality of sequential stages for transitioning an individual from a candidate status to an onboarded status of an organization, each one of the plurality of sequential stages having one or more tasks associated therewith, such that completion of the one or more tasks associated with a preceding one of the plurality of sequential stages is required before performing the one or more tasks associated with a current one of the plurality of sequential stages;
tracking completion of the one or more tasks for each one of the plurality of sequential stages; and
automatically notifying, on a periodic basis, a supervising entity of which one of the sequential stages the individual is currently in based on tracking completion of the one or more tasks for each one of the plurality of sequential stages.

20. The computer program product of claim 19, wherein the operations further comprise:
using an artificial intelligence engine to predict an onboarding satisfaction score for the individual; and
using the artificial intelligence engine to identify an attention needing task from the one or more tasks corresponding to any of the plurality of sequential stages that presents a risk for negatively impacting the onboarding satisfaction score for the individual.
